(19) United States
(12) Patent Application Publication
(10) Pub. No.: US 2003/0226900 A1
(43) Pub. Date: Dec. 11, 2003

(54) Electronic tags

(76) Inventors: Christopher Brian Taylor Latham, Cumbria (GB); David Richard Norrie, Cumbria (GB)

Correspondence Address: Stephen M. De Klerk, BLAKELY, SOKOLOFF, TAYLOR & ZAFMAN LLP, 12400 Wilshire Boulevard, Seventh Floor, Los Angeles, CA, 90025-1026, US

(21) Appl. No.: 10/394,838

(22) Filed: Mar. 21, 2003

(30) Foreign Application Priority Data
Mar. 23, 2002 (GB) 0206905.2

(51) Int. Cl. G06K 19/06

(52) U.S. Cl. 235/492

(57) ABSTRACT

The present invention discloses an electronic tag comprising electronic circuitry incorporating a microprocessor (44), a non-volatile memory associated with the microprocessor (44) such that the microprocessor (44) can write data to the non-volatile memory, a sensing transducer (54) connected to the microprocessor (44), and an interface (30) for interrogation of the non-volatile memory, the sensing transducer (54). being such as to output an electrical signal in response to an event of a pre-selected type, the microprocessor (44) being programmed to log signals from the sensing transducer (54) to the non-volatile memory to produce a record of the selected event and being arranged to be powered by the electrical output signal from the sensing transducer (54).

The present invention relates to developments in electronic tag technology.

Compact electronic data modules, or electronic “tags”, are in themselves well known and take a wide variety of forms. Some means of obtaining and/or storing information is required along with an electronic means for interfacing with a separate reader. Some tags are used simply to store an identifying code. Others have read/writeable memory and to avoid a need for constant power supply, and the danger of loss of information in the event of interruption of the power supply, such memories are preferably non-volatile (ie. capable of retaining information even when not energized by any supply). Some tags are adapted to be interrogated through a “wand” which makes direct electrical contact when offered up to the tag Others are provided with a radio frequency (RF) interface.

While the data stored on a tag may be written to it through such an interface, a type of tag of particular interest for present purposes receives information from some other source, for example a transducer (which may be part of the tag) measuring some physical parameter such as temperature. This may be additional to the facility to write data to the tag through the interface.

Reading and writing information from/to the tag requires electrical power. Many tags have an on board battery to supply this and the tag is thereby enabled to operate almost autonomously, recording sensed events as data in memory and requiring interaction with an external reading device only for retrieval of this data. However incorporation of a battery adds to the bulk of the tag and makes periodic recharging or replacement necessary. Furthermore use of batteries is prohibited in certain contexts, e.g. in connection with explosives. The applicant's published European Patent Application 00302679.6 (publication No. 1041516) discloses a tag which is to be electrically connected to a host electrical apparatus in order to record data such as the total time for which the host is operational. This tag thus requires no on board power supply and is powered up only when the host supply is turned on, or when interrogated by means of a wand which, through contact with electrodes on the tag, both supplies power to and exchanges information with the tag. While useful in the right context, the tag is clearly not suitable e.g.. for use in tagging an item lacking its own electrical supply.

The several aspects of the present invention are addressed to problems in powering electronic tags.

In accordance with a first aspect of the present invention there is an electronic tag comprising electronic circuitry incorporating a microprocessor, a non-volatile memory associated with the microprocessor such that the microprocessor can write data to the non-volatile memory, a sensing transducer connected to the microprocessor, and an interface for interrogation of the non-volatile memory, the sensing transducer being such as to output an electrical signal in response to an event of a pre-selected type and the microprocessor being programmed to log signals from the sensing transducer to the non-volatile memory to produce a record of the selected event and being arranged to be powered by the electrical output signal from the sensing transducer.

A tag is thus provided which need not include a battery and which can log events detected by the transducer.

Preferably the tag further comprises a capacitor connected to the sensing transducer such as to be charged by the electrical output signal, the capacitor also being connected to the microprocessor so that subsequent discharge of the capacitor powers the microprocessor.

Hence energy acquired from the transducer can be stored to run the tag for a period of time.

Preferably the interface is a wireless interface.

It is particularly preferred that the wireless interface is arranged to supply electrical power to the microprocessor enabling the microprocessor to be driven by energy received through the interface from an interrogating electromagnetic field.

In a preferred embodiment the microprocessor is arranged to be powered by the electrical output signal from the sensing transducer in carrying out logging and to be powered from the interface during interrogation of the non-volatile memory through the interface.

In a further preferred embodiment the microprocessor is arranged to log an indication of the strength of the electrical signal from the sensing transducer. Still more preferably the microprocessor is programmed to log an indication of the strongest signal received from the sensing transducer.

In yet a further preferred embodiment the microprocessor is arranged to measure time and to log the time of events. This may be achieved by arranging that the microprocessor is connected to a capacitor such as to measure capacitor potential and to interpret capacitor potential as an indication of time.

In accordance with a second aspect of the present invention there is an electronic tag comprising electronic circuitry incorporating a sensor, a wireless interface, and control electronics for outputting sensor data through the wireless interface, wherein the electrical signal induced in the interface by an interrogating wireless field is utilized to power the tag's electronic circuitry.

It is particularly preferred that the tag further comprises a non-volatile memory, the control electronics being connected thereto for writing sensor data to the memory and for enabling data from the memory to be output through the wireless interface.

In a preferred embodiment the tag is adapted to utilize the energy received from the interrogating field to log a reading from the sensor to the memory. The energy from the field may additionally or alternatively be utilized to send a response signal through the interface for receipt by an interrogating device.

Such a tag may be constructed without any onboard energy source. Alternatively, however, and in a preferred embodiment of the invention, the tag may further comprise an onboard electrical power source and be adapted to carry out periodic data logging even in the absence of an interrogating field. In such an embodiment the energy received from the interrogating field may be utilized to provide the power needed to send a response signal through the interface for receipt by an interrogating device. Thus this type of tag can have a very small power requirement, sufficient only to carry out data logging, and a correspondingly small onboard energy supply. This may comprise a battery but may, in a particularly preferred embodiment comprise a capacitor.

The tag according to the second aspect of the present invention is preferably incorporated in a data logging system comprising an interrogation device for periodically emitting an interrogating radio or microwave field. Hence the tag, or a set of tags, can be periodically activated to log a measurement. The interrogation device may further be adapted to encode a time signal in the emitted field so that the tag can log the time of the measurement.

In accordance with a third aspect of the present invention there is an electronic tag comprising a sensor, an interface, control electronics connected to the sensor and the interface for outputting sensor data through the interface, and a capacitor whose discharge powers the tag.

Capacitors are available commercially which are specially designed as replacements for batteries. The discharge time can be several days although of course the current output is small. The present inventor has recognized that the output from such capacitors is nonetheless sufficient to drive low power circuitry suitable for an electronic tag.

It is particularly preferred that the tag further comprises a memory, the control electronics being connected to the memory for writing sensor data to the memory.

In a particularly preferred embodiment, the tag is adapted to monitor or to log capacitor potential. The decay of charge on the capacitor can be used as an indication of elapsed time. Hence in one such embodiment the tag is adapted to log capacitor potential or some variable related thereto along with a sensor reading. In this way the elapsed time when the sensor reading is taken can be obtained on subsequent interrogation of the tag. Such a tag could provide a simple way to monitor whether, for example, the shelf life of a food item had been exceeded.

In a further preferred embodiment the sensor is a temperature sensor. Such a tag may be used to monitor the temperature profile of food, for example. It could be attached to a frozen food item or consignment and adapted to log any occasion when the measured temperature fell outside a chosen range, to provide assurance of proper storage conditions. It could alternatively be adapted to make a periodic log to provide a temperature/time profile.

Preferably the capacitor is arranged to be charged through the interface during interrogation of the tag. One such embodiment of the invention has an interface having electrical terminals for contact with an interrogation device, the capacitor being connected to the terminals such as to receive current from the interrogation device. Another such device, embodying the present invention, has a wireless interface and is adapted to supply energy received from an interrogating wireless field to charge the capacitor.

In accordance with a fourth aspect of the present invention, there is an electronic tag comprising electronic circuitry incorporating a transducer, a non-volatile memory, a control, and an interface through which the tag can be interrogated, wherein the transducer is such as to output an electrical signal in response to an event of a preselected type and is connected to the control such that the electrical signal produced in response to the event powers the control in logging the signal to the memory, thereby providing a record of the event.

By using energy obtained through the transducer by reason of the event to create the required record of it, the need for an onboard power supply can again be avoided.

The event in question is typically some form of mechanical action on the tag.

In the most preferred embodiment of this aspect of the invention the transducer is of piezoelectric type. A piezo-electric transducer emits an electrical signal in response to a transient applied force. Such a tag is most preferably adapted to monitor mechanical shock levels, which a piezo-electric transducer is well suited to. It may for example be adapted to log the greatest shock to which a host item is subject, for warranty purposes or to ensure proper treatment during transportation.

The control may comprise a microprocessor.

In a further preferred embodiment, the electronic circuitry further incorporates a capacitor dischargeable through the circuitry to thereby drive same. The capacitor may be arranged to be charged by the transducer when subject to an event of the selected type. It may additionally or alternatively be arranged to be charged through the interface during interrogation of the tag.

In accordance with a fifth aspect of the present invention, there is an electronic tag comprising electronic circuitry incorporating an interface through which the tag can be interrogated, and means for inductively coupling to an AC power line to thereby supply electrical power to the circuitry.

In this way the tag can be powered from a host supply without the need for direct electrical connection to it.

Preferably the tag further comprises a memory and control electronics enabling copying of data to the memory and exchange of data through the interface.

In any of the second, third, fourth and fifth above mentioned aspects of the present invention, the control may be provided in the form of a microprocessor. The memory and control can be formed by a single integrated circuit, examples of which are commercially available.

Tags according to all aspects of the present invention may be for logging any one or more of the following physical properties:

I. mechanical shock or vibration;

ii. temperature;

iii voltage;

iv current;

v humidity;

vi position;

vii orientation.

Specific embodiments of the present invention will now be described, by way of example only, with reference to the accompanying drawings in which:

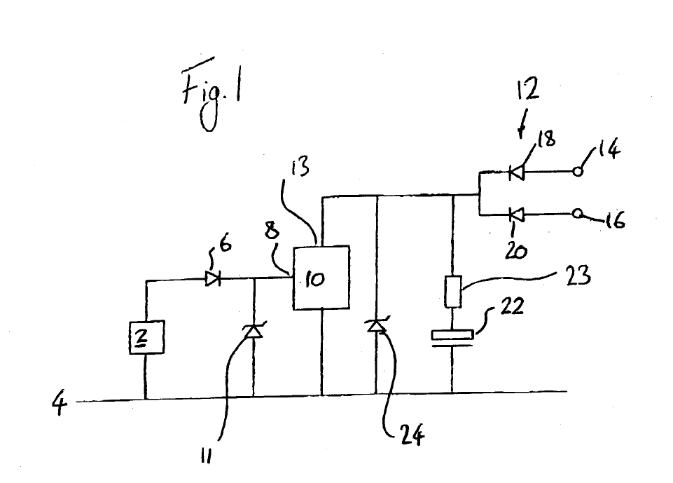

FIG. 1 is a circuit diagram of a first tag embodying the invention; and

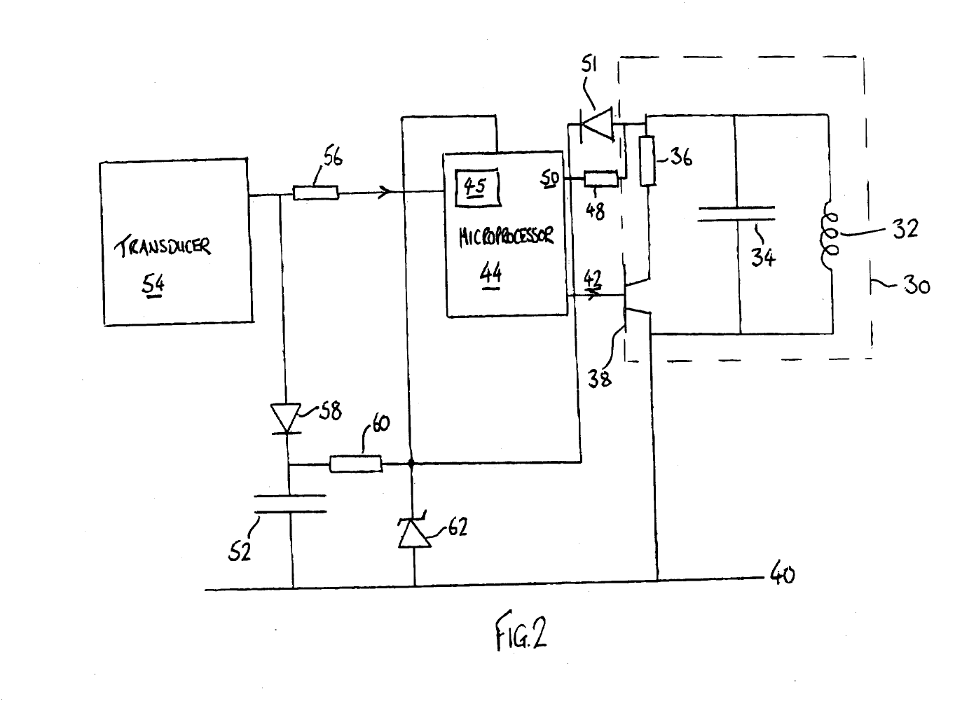

FIG. 2 is a further circuit diagram of a second tag embodying the invention.

In the circuit of FIG. 1, a piezo-electric transducer 2 is connected on one side to a common line 4 and on its other side via a diode 6 to an input configured pin 8 of a microprocessor 10. A zener diode 11 connected between the input pin 8 and the common line 4 provides protection for the microprocessor against excess voltage from the transducer 2. A further pin 13 of the microprocessor is connected to an interface 12 which in this embodiment comprises simply a pair of contacts 14, 16 each with an associated diode 18, 20. The present tag is thus adapted to be interrogated using a “wand” having contacts which are brought into abutment with the contacts 14, 16 to both read/write tag data and supply power to the tag. Connected between the interface and the common line 4 is a capacitor 22 of the special type referred to above, having a long discharge time (a so-called “supercap”), in series with a resistor 23. The capacitor is charged from the wand during interrogation and its subsequent discharge provides power to the tag to carry out periodic data logging. Hence the tag can be powered in any of three different ways:

I during interrogation, from the wand;

ii by the capacitor 22; or

iii transiently by the piezo-electric transducer 2.

Protection against excess voltage applied through the interface is provided by means of a second zener diode 24. The microprocessor 10 provides both the control function for the tag and its (non-volatile) memory. The tag serves to record shocks or vibrations, representative signals from the transducer 2 being logged by the microprocessor 10.

Whereas the embodiment illustrated in FIG. 1 is to be interrogated by means of direct electrical contacts, the FIG. 2 embodiment utilizes a wireless interface, the components of which are seen in dashed box 30. In the illustrated embodiment this is a radio interface The operating frequency for a particular application of the tag is chosen with particular reference to official regulations but is typically above 100 kHz. Available frequencies in the UK include 134 kHz and 13.56 MHZ. Another factor affecting the choice of frequency is the aerial, which is typically incorporated within the tag itself so that its dimensions are limited. A printed band antenna can be used above 100 kHz and is suited to a compact tag. Nonetheless lower frequencies could be used in certain embodiments.

The radio interface 30 comprises a tuned circuit formed by a parallel combination of an inductor 32 and a capacitor 34. Also connected across these components is a series combination of a limiter resistor 36 and a switching transistor 38, the latter being led to a common rail 40. The switching transistor 38 is controlled by an output 42 from a microprocessor 44. To output data through the interface a suitably modulated signal is applied by the microprocessor through output 42 to drive the transistor 38 and hence the tuned circuit. Signals received by the interface are led through a resistor 48 to an input 50 of the microprocessor. Additionally the tuned circuit is connected through a diode 51 to a high side of a power supply capacitor 52, connected on its opposite side to the common rail 40, and in this way energy received from an interrogating radio field is used to replenish charge on the capacitor 52.

In FIG. 2 a box 54 represents a transducer. A wide range of physical parameters can be monitored by tags embodying the present invention but in the illustrated example the transducer is of piezo-electric type and is used to monitor physical shocks to which a piece of equipment (on which the tag is mounted) is subject. Hence e.g. inappropriate handling of equipment in transit can be recorded.

The transducer produces an electrical output signal representative of the monitored physical parameter and this is led via a resistor 56 to an input of the microprocessor 44. In addition the output of the transducer is connected through a diode 58 to the power supply capacitor 52 so that energy received from the transducer replenishes the capacitor's charge. Time decay of the capacitor charge may be used as a measure of elapsed time.

The capacitor supplies a very small electrical power to the microprocessor through a resistor 60 which is additionally connectable to the common rail through a zener diode 62 to protect the microprocessor from excess voltage.

The microprocessor has an on-board non volatile memory 45 and stores operating software as well as having capacity to store data received from the transducer 54 and in some embodiments also data received through the interface 30.

The transducer 54 may be temperature sensitive. There are many applications for a temperature sensing tag. The microprocessor 44 can, using power from the capacitor 52, run a real time clock and carry out periodic logging of the monitored physical parameter. Hence for example a temperature profile over time can be recorded which is useful e.g. for monitoring the treatment of foodstuffs. Time decay of the capacitor charge may be used as a measure of elapsed time.

The example illustrated in FIG. 2 uses energy from both the interface 30 and the transducer 54, stored in the capacitor 52, to power the tag. However any of these three sources, individually or in any combination, could be used for power. For example the capacitor and transducer could be dispensed with so that the tag could be powered up (from the interface 30) only when interrogated. The capacitor could be dispensed with, or have a relatively small capacitance, in a tag which was to be powered up only in response to a signal from its transducer or its interface.

The microprocessor 44 can be an off the shelf programmable controller with suitable control software stored in a flash memory. Suitable controllers will be known to those skilled in this field but include the AVR from Atmel and the MPS 430 from Texas Instruments.

What is claimed is:

1. An electronic tag comprising electronic circuitry incorporating a microprocessor, a non-volatile memory associated with the microprocessor such that the microprocessor can write data to the non-volatile memory, a sensing transducer connected to the microprocessor, and an interface for interrogation of the non-volatile memory, the sensing transducer being such as to output an electrical signal in response to an event of a pre-selected type and the microprocessor being programmed to log signals from the sensing transducer to the non-volatile memory to produce a record of the selected event and being arranged to be powered by the electrical output signal from the sensing transducer.

2. An electronic tag as claimed in claim 1 further comprising a capacitor connected to the sensing transducer such as to be charged by the electrical output signal, the capacitor also being connected to the microprocessor so that subsequent discharge of the capacitor powers the microprocessor.

3. An electronic tag as claimed in claim 1 wherein the interface is a wireless interface.

4. An electronic tag as claimed in claim 3 wherein the interface comprises a tuned circuit connected in parallel with a switching transistor, the transistor being connected to an output of the microprocessor whereby during interrogation of the tag a signal in the tuned circuit is modulated under the control of the microprocessor.

5. An electronic tag as claimed in claim 3 wherein the wireless interface is arranged to supply electrical power to the microprocessor enabling the microprocessor to be driven by energy received through the interface from an interrogating electromagnetic field.

6. An electronic tag as claimed in claim 1 wherein the microprocessor is arranged to be powered by the electrical output signal from the sensing transducer in carrying out logging and to be powered from the interface during interrogation of the non-volatile memory through the interface.

7. An electronic tag as claimed in claim 1 wherein the sensing transducer is a piezoelectric transducer.

8. An electronic tag as claimed in claim 7 which is adapted to log physical shocks to which the tag is subject.

9. An electronic tag as claimed in claim 1 wherein the microprocessor is arranged to log an indication of the strength of the electrical signal from the sensing transducer.

10. An electronic tag as claimed in claim 9 wherein the microprocessor is programmed to log an indication of the strongest signal received from the sensing transducer.

11. An electronic tag as claimed in claim 1 wherein the microprocessor is arranged to measure time and to log the time of events.

12. An electronic tag as claimed in claim 11 wherein the microprocessor is connected to a capacitor such as to measure capacitor potential and to interpret capacitor potential as an indication of time.

13. An electronic tag as claimed in claim 1 wherein the interface comprises electrical contacts connected to the microprocessor and contactable by means of a separate reader for interrogation of the tag.

14. An electronic tag comprising electronic circuitry incorporating a transducer, a non-volatile memory, a control, and an interface through which the tag can be interrogated, wherein the transducer is such as to output an electrical signal in response to an event of a pre-selected type and is connected to the control such that the electrical signal produced in response to the event powers the control in logging the event to the non-volatile memory, thereby providing a record of the event.

15. An electronic tag as claimed in claim 14 wherein the transducer is a piezoelectric transducer.

16. An electronic tag as claimed in claim 15 further comprising a capacitor dischargeable through the circuitry to drive the circuitry.

17. An electronic tag as claimed in claim 16 wherein the capacitor is arranged to be charged from the transducer.

18. An electronic tag as claimed in claim 16 wherein the capacitor is arranged to be charged through the interface during interrogation of the tag.

19. An electronic tag as claimed in claim 16 wherein the capacitor is arranged to be charged from the transducer and also to be charged through the interface during interrogation of the tag.
